(19) United States
(12) Patent Application Publication
(10) Pub. No.: US 2024/0025271 A1
(43) Pub. Date: Jan. 25, 2024

(54) LOW LOSS ELECTRIC DRIVE SPEED GUIDELINE SYSTEM FOR ELECTRIC VEHICLES

(71) Applicant: GM Global Technology Operations LLC, Detroit, MI (US)

(72) Inventors: Muhammad Hussain Alvi, Troy, MI (US); Chunhao J. Lee, Troy, MI (US); Suresh Gopalakrishnan, Troy, MI (US); Junfeng Zhao, Troy, MI (US); Chen-fang Chang, Bloomfield HIlls, MI (US)

(21) Appl. No.: 17/870,145

(22) Filed: Jul. 21, 2022

(51) Int. Cl. B60L 15/20; B60W 10/08

(52) U.S. Cl. CPC B60L 15/2045; B60W 10/08; B60L 2240/421; B60L 2240/423

(57) ABSTRACT

An electric vehicle, an electric drive system and method of operating the electric vehicle. The electric drive system provides a torque to a wheel of the electric vehicle. The processor is configured to obtain a value of the torque at which the electric drive system of the vehicle is operating, determine an optimal speed for the vehicle for the torque based on an efficiency model of the electric drive system, wherein the optimal speed corresponds to an optimal drive efficiency for the electric drive system, and operate the vehicle at the optimal speed.

### INTRODUCTION

The subject disclosure relates to electric vehicles and, in particular, to a system and method for operating an electric vehicle at speeds that optimize an electrical efficiency of the electric vehicle.

An electric vehicle includes a machine or motor that converts electrical energy into mechanical energy, specifically into a rotational torque. This torque is transferred from the motor to a wheel of the vehicle to cause the vehicle to move. The efficiency at which this torque is transferred is affected by parameters such as thermal heating, road load, etc. In order to increase the range of the vehicle, it is desirable that the conversion of electrical energy into vehicle motion is performed efficiently. Accordingly, it is desirable to determine, for a given torque, an optimal vehicle speed that achieves optimal energy efficiency for the vehicle.

### SUMMARY

In one exemplary embodiment, a method of operating an electric vehicle is disclosed. A value is obtained of a current torque at which an electric drive system of the vehicle is operating. A processor determines an optimal speed for the vehicle for the current torque based on an efficiency model of the electric drive system, wherein the optimal speed corresponds to an optimal drive efficiency for the electric drive system. The vehicle is operated at the optimal speed.

In addition to one or more of the features described herein, the method further includes selecting a speed trace corresponding to the current torque from the efficiency model and locating the optimal speed using the speed trace. The optimal speed corresponds to one of a global optimal efficiency of the speed trace and a local optimal efficiency within a bounded speed region of the speed trace defined by a constraint. The method further includes selecting a plurality of speed traces from within a neighborhood of the current torque and determining the optimal drive efficiency using the plurality of speed traces. The efficiency model is one of a drive efficiency model for the electric drive system, an inverter efficiency model for an inverter, and a motor efficiency model for an electric motor. Operating the vehicle at the optimal speed includes one of applying the optimal speed autonomously and displaying a speed range for the optimal speed to a driver of the vehicle. The method further includes determining the optimal speed based on a relation between vehicle speed and a drag force on the vehicle.

In another exemplary embodiment, an electric drive system for an electric vehicle is disclosed. The electric drive system includes a processor. The processor is configured to obtain a value of a current torque at which the electric drive system of the vehicle is operating, determine an optimal speed for the vehicle for the current torque based on an efficiency model of the electric drive system, wherein the optimal speed corresponds to an optimal drive efficiency for the electric drive system, and operate the vehicle at the optimal speed.

In addition to one or more of the features described herein, the processor is further configured to select a speed trace corresponding to the current torque from the efficiency model and locate the optimal speed using the speed trace. The optimal speed corresponds to one of a global optimal efficiency of the speed trace and a local optimal efficiency within a bounded speed region of the speed trace defined by a constraint. The processor is further configured to select a plurality of speed traces from within a neighborhood of the current torque and determine the optimal drive efficiency using the plurality of speed traces. The efficiency model is one of a drive efficiency model for the electric drive system, an inverter efficiency model for an inverter, and a motor efficiency model for an electric motor. The processor is further configured to operate the vehicle at the optimal speed by performing one of applying the optimal speed autonomously and displaying a speed range for the optimal speed to a driver of the vehicle. The processor is further configured to determine the optimal speed based on a relation between vehicle speed and a drag force on the vehicle.

In another exemplary embodiment, an electric vehicle is disclosed. The electric vehicle includes an electric drive system and a processor. The electric drive system that provides a current torque to a wheel of the electric vehicle. The processor is configured to obtain a value of the torque at which the electric drive system of the vehicle is operating, determine an optimal speed for the vehicle for the current torque based on an efficiency model of the electric drive system, wherein the optimal speed corresponds to an optimal drive efficiency for the electric drive system, and operate the vehicle at the optimal speed.

In addition to one or more of the features described herein, the processor is further configured to select a speed trace corresponding to the current torque from the efficiency model and locate the optimal speed using the speed trace. The optimal speed corresponds to one of a global optimal efficiency of the speed trace and a local optimal efficiency within a bounded speed region of the speed trace defined by a constraint. The processor is further configured to select a plurality of speed traces from within a neighborhood of the current torque and determine the optimal drive efficiency using the plurality of speed traces. The processor is further configured to operate the vehicle at the optimal speed by performing one of applying the optimal speed autonomously and displaying a speed range for the optimal speed to a driver of the vehicle. The processor is further configured to determine the optimal speed based on a relation between vehicle speed and a drag force on the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in an illustrative embodiment;

FIG. 2 shows a schematic diagram illustrating an overview of an optimization operation performed by a controller of the vehicle;

FIG. 3 illustrates an illustrative relation between motor torque and optimal speed for the vehicle;

FIG. 4 shows a flowchart illustrating a method of optimization using the drive efficiency model of FIG. 3;

FIG. 5 illustrates a process by which an optimal efficiency value can be determined using the drive efficiency model of FIG. 3;

FIG. 6 shows a flowchart depicting a method for implementing a speed at the vehicle that operates the vehicle at an optimal drive efficiency;

FIG. 7 shows a speedometer with the range of speeds illuminated for a driver;

FIG. 8 shows efficiency models for sub-components of the drive system; and

FIG. 9 illustrates an optimization operation for a limp home mode in which extra devices are turned off.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, FIG. 1 shows a vehicle 100. The vehicle 100 includes an electric power supply 102, such as a battery, coupled to a drive system 104. In an embodiment, the drive system 104 is an electric drive system that includes an inverter 106 and an electric motor 108. The inverter 106 couples the electric power supply 102 to the electric motor 108 and converts a DC current from the electric power supply 102 into an AC current that can be used at the electric motor. The electric motor 108 is coupled to one or more wheels 110 of the vehicle 100 via a transmission shaft 112. The electric motor 108 converts electrical energy from the electric power supply 102 into a rotation of the transmission shaft 112. The drive system 104 converts the rotation of the transmission shaft 112 into a rotational speed of the one or more wheels 110, thereby causing the vehicle 100 to move at a selected speed. A controller 114 can obtain parameters of the inverter 106 and the electric motor 108 and can determine an optimal speed at which to rotate the one or more wheels that operates the drive system 104 at an optimal efficiency for a given torque. The controller 114 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 114 may also include a non-transitory computer-readable medium that stores instructions which are processed by one or more processors of the controller to implement processes detailed herein. In one embodiment, the controller 114 can be in communication with a remote server 116 which can provide efficiency models for use in operation of the vehicle 100. In one embodiment, the controller 114 can operate the vehicle 100 as an autonomous vehicle or in an autonomous mode. In another embodiment, the controller 114 can provide information to a driver and perform various cruise control operations of the vehicle 100.

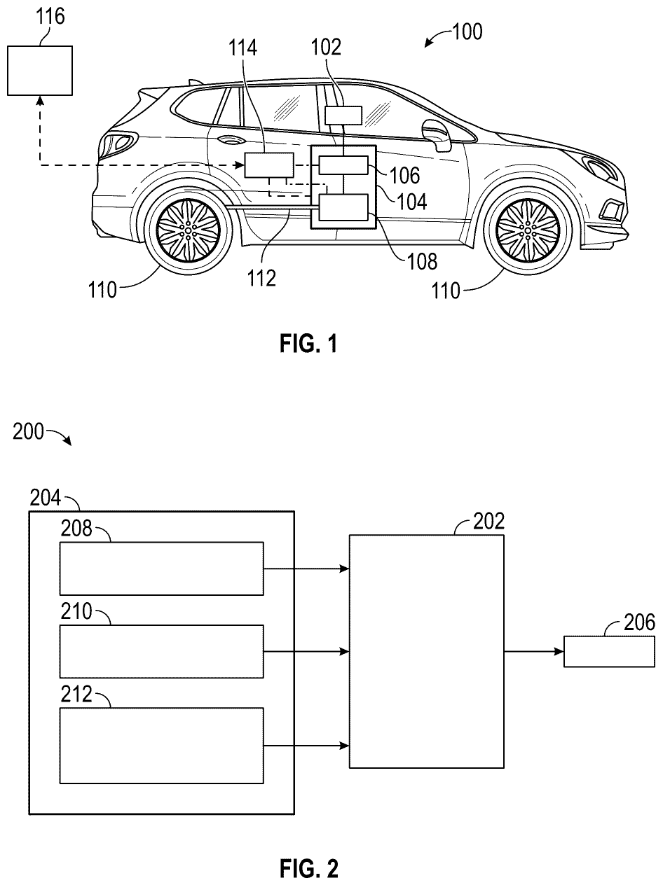

FIG. 2 shows a schematic diagram 200 illustrating an overview of an optimization operation performed by the controller 114 and/or its processor. The optimization operation determines a speed at which to rotate the one or more wheels 110 (or equivalently, to move the vehicle 100) in order to operate the drive system 104 at an optimal or peak efficiency for a given torque. The optimization operation uses an efficiency model 202 that maps an electrical efficiency for the drive system 104 as a function of torque and wheel speed. Inputs 204 are used at the efficiency model 202, which outputs an optimal speed 206 (i.e., a wheel speed) which optimizes a drive efficiency for the vehicle 100. The inputs can include protection data 208 for subsystems of the drive system 104, road load data 210, and boundary conditions 212.

The drive system 104 can include the inverter 106 and the electric motor 108 as its subsystems. Thus, an efficiency model for the drive system 104 is a product of an inverter efficiency model for the inverter 106 and a motor efficiency for the electric motor 108. In various embodiments, the contribution of the motor efficiency or the inverter efficiency is considered (rather than the drive efficiency) when determining the optimal wheel speed. In other words, the optimization process can locate a maximum of either the motor efficiency model or the inverter efficiency model, rather than of the drive efficiency model.

The road load data 210 includes additional forces on the vehicle, such as a drag force and other friction values. As discussed herein the drag force is dependent on the speed of the vehicle. The boundary conditions 212 can include constraints on the vehicle, such as speed limit, etc.

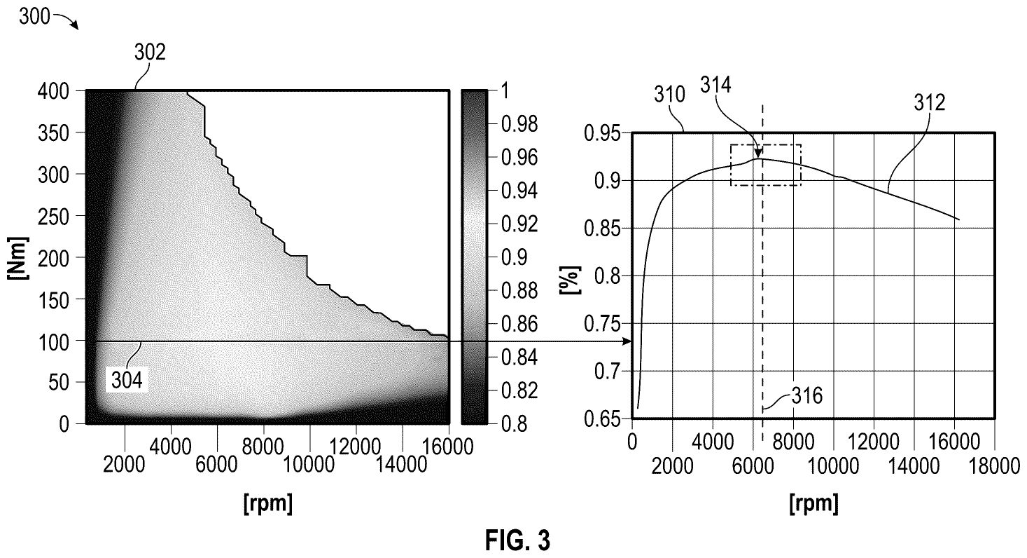

FIG. 3 illustrates a relation 300 between motor torque and optimal speed for the vehicle 100, in an illustrative embodiment. FIG. 3 shows a drive efficiency model 302 for the drive system, in an illustrative embodiment. The drive efficiency model 302 can be created based on laboratory testing of the vehicle 100 or similar vehicle or based on a simulation of the vehicle 100. The drive efficiency model 302 can be loaded into a controller 114 of the vehicle 100 either during manufacture of the vehicle or once the vehicle is being used, via wireless communication from a model server (i.e., remote server 116) to the vehicle 100. The drive efficiency model 302 includes a torque-speed plane with efficiency values located therein. Speed is shown along the abscissa in revolutions per minute (rpm) and torque is shown along the ordinate axis in Newton-meters (Nm). The efficiency values are indicated by different colors, topology lines or other suitable representative values.

FIG. 3 further shows a graph 310 of a cross section of the torque-speed plane of the drive efficiency model 302 for a given torque value (i.e., along constant torque line 304). The graph 310 includes a speed trace 312 that represents the efficiency values at different speeds for the given torque value (i.e., for a torque of 100 Newton-meters). Speed trace 312 illustrates how the drive efficiency at a given torque changes with rotational speed of the wheel. Speed trace 312 reaches a global maximum efficiency 314 (or global optimal efficiency) within a given speed range (e.g., between about 6,000 rpm and about 8,000 rpm). The controller 114 can locate this global maximum efficiency 314 and thus determine the optimal speed 316.

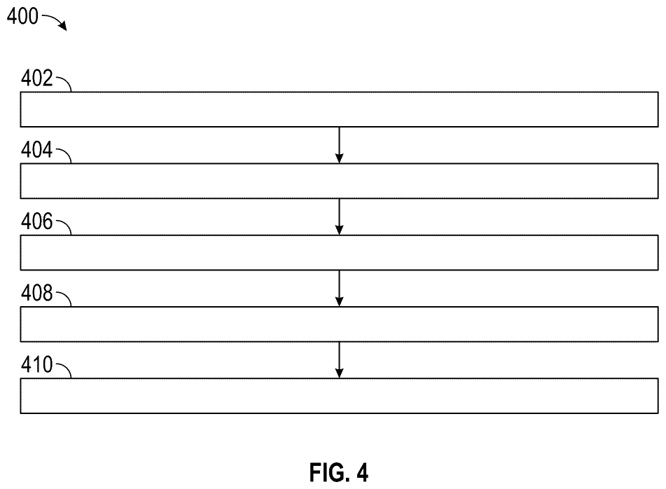

FIG. 4 shows a flowchart 400 illustrating a method of optimization using the drive efficiency model 302. In box 402, a torque of the motor or drive system is determined. In box 404, the torque is used to select a speed trace from the drive efficiency model 302. In box 406, an optimal drive efficiency is located along the speed trace. In box 408, an optimal speed corresponding to the optimal drive efficiency is determined. In box 410, the vehicle is operated at the optimal speed.

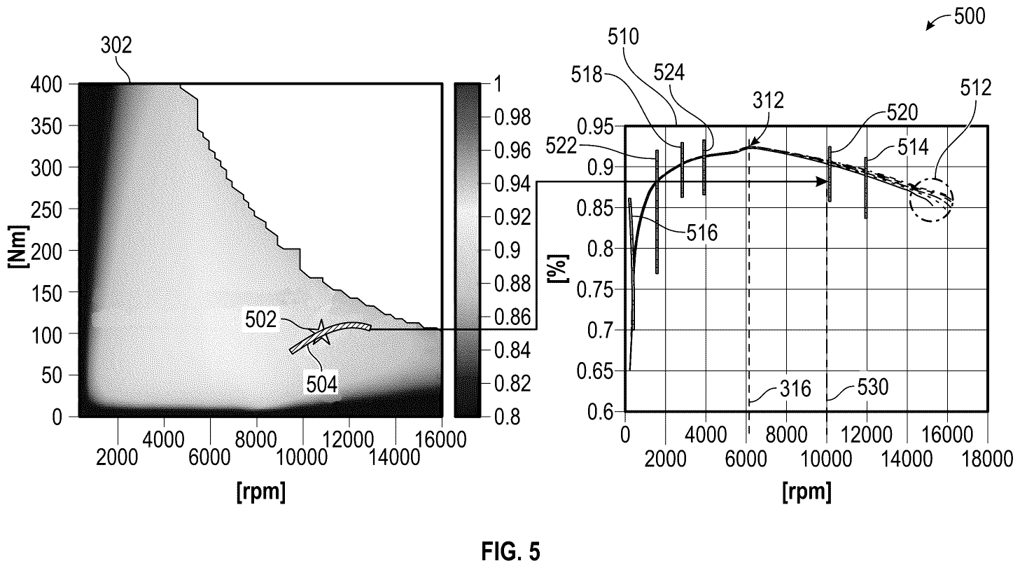

FIG. 5 illustrates a process 500 by which an optimal efficiency value can be determined using the drive efficiency model 302 of FIG. 3. A current operating point 502 (or present operating point) is shown in the drive efficiency model 302. The current operating point 502 represents a current torque and current speed at which the vehicle is operating. A selection curve 504 is drawn through the current operating point 502. A plurality of speed traces can be selected from the drive efficiency model 302 corresponding to a plurality of torques within the selection curve 504.

Graph 510 shows speed traces 512 for each of the plurality of torques in the neighborhood of the current torque. An optimal efficiency (or local optimal efficiency) can be located along the speed traces 512 based on a current speed of the vehicle. For illustrative purposes, a first starting speed 514, second starting speed 516 and third starting speed 518 are indicated in graph 510.

For a vehicle operating at first starting speed 514, the controller 114 locates a first optimal efficiency 520 along the speed traces 512. The first optimal efficiency may be bounded within a speed region due to various constraints on the vehicle 100, such as a speed limit or other boundary conditions. Due to the bounded speed region, it is understood that the first optimal efficiency 520 can be different from the global maximum efficiency 314. Thus, while the speed of the vehicle can be adjusted from the first starting speed 514 to a first final operating speed 530 within the speed region, the controller 114 may decide not to operate, or may be restricted from operating, the vehicle at the optimal speed 316.

Similarly, a second local optimal efficiency 522 can be located when the vehicle is initially operating at the second starting speed 516, and a third local optimal efficiency 524 can be located when the vehicle is initially operating at the third starting speed 518. The second local optimal efficiency 522 and the third local optimal efficiency 524 are similarly constrained by their particular boundary conditions, speed limits, etc.

In determining the optimal speed, the controller also considers a drag force (or road load) on the vehicle created due to speed of the vehicle 100. The drag force Fa is a function of the vehicle's velocity V, as shown in Eq. (1):

F_{d}=C₀+C₁V+C₂V² Eq. (1)

where C₀, C₁, and C₂ are known coefficients. If the change in torque is less than a given threshold (e.g., a few percent), the optimization procedure can occur in one dimension (e.g., using the speed trace 312) If the change in torque is greater than or equal to the given threshold, the optimization procedure can occur in two dimensions (e.g., using the plurality of speed traces 512 on different torques).

It is noted that the drive efficiency models and their associated graphs and speed traces are shown for illustrate purposes only. The location of local maxima and of the global maximum will change with the type of system or type of vehicle.

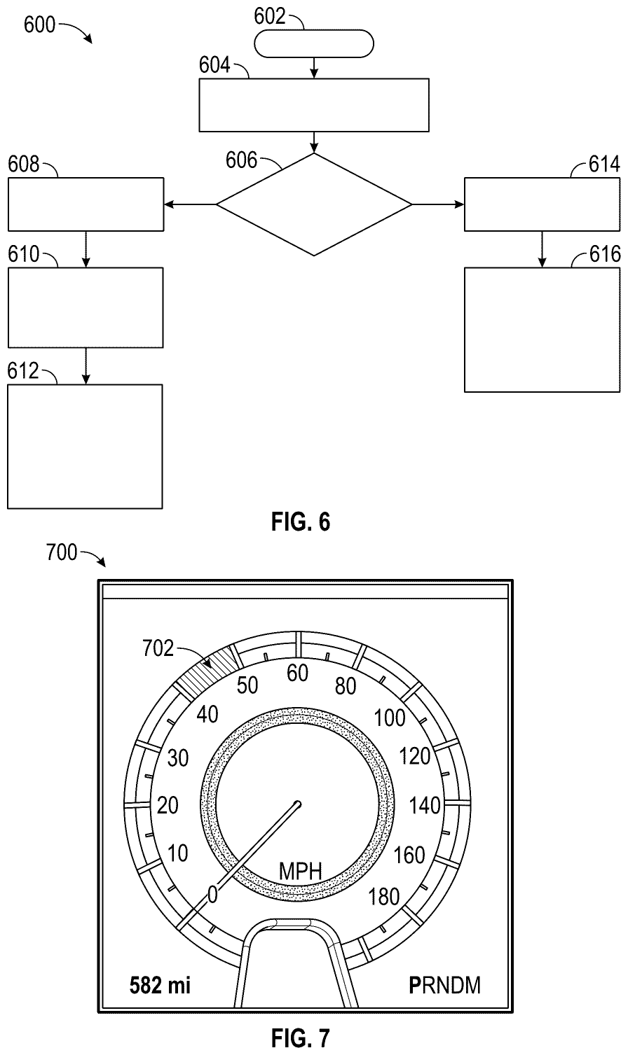

FIG. 6 shows a flowchart 600 depicting a method for implementing a speed at the vehicle that operates the vehicle at an optimal drive efficiency. The method starts at box 602. In box 604, information about vehicle status and road load conditions is obtained. In box 606, it is determined whether the vehicle is being driven in an autonomous mode or in a cruise control mode. If the vehicle is being driven in a cruise control mode, the method proceeds to box 608. In box 608, cruise control settings are obtained. These cruise control settings include a range of speeds at which the driver is operating the vehicle. These settings can be set or selected by the driver. In box 610, the local optimal speed is located within the boundary conditions set by the cruise control settings. The local optimal speed can be a single speed or a range of speeds. In box 612, the range of speeds can be displayed or highlighted on a speedometer for viewing by the driver. FIG. 7 shows a speedometer 700 with the range of speeds 702 illuminated for the driver.

Returning to FIG. 6 and to box 606, if the vehicle is being driven in an autonomous mode, the method proceeds to box 614. In box 614, the drive efficiency model and speed traces are used to determine an optimal speed for the vehicle. In box 616, the optimal speed is used as output to propel the vehicle.

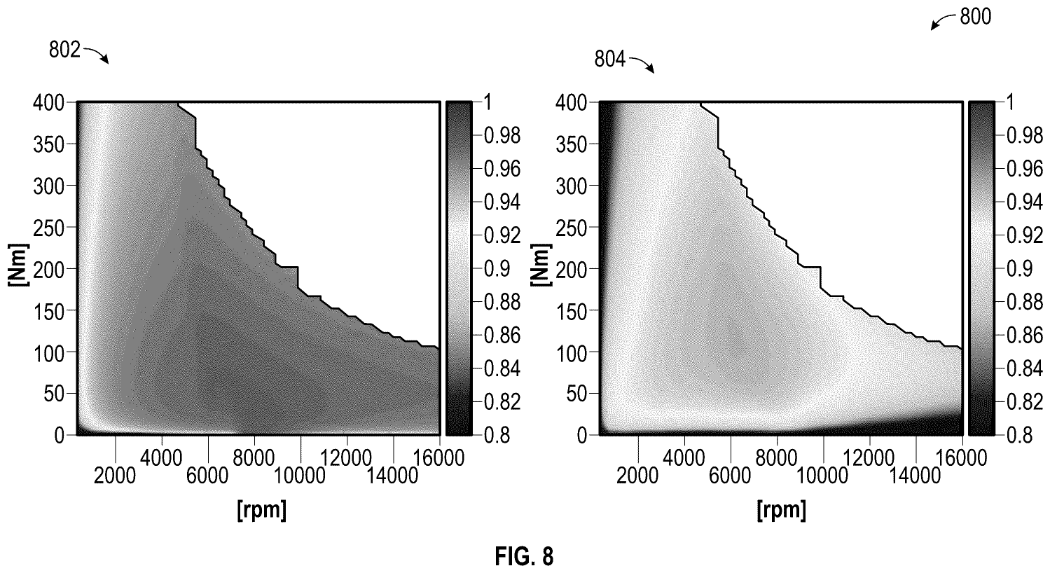

FIG. 8 shows efficiency models 800 for sub-components of the drive system 104. Shown in FIG. 8 are an inverter efficiency model 802 and a motor efficiency model 804. In combination, these models make up the drive efficiency model. In various embodiments, the optimization process can be performed using either the inverter efficiency model 802 or a motor efficiency model 804. For example, when the inverter 106 is heating up, the inverter efficiency model 802 can be used for speed selection rather than the drive efficiency model 302. Similarly, if the motor is heating up, the motor efficiency model 804 can be used for speed selection rather than the drive efficiency model 302.

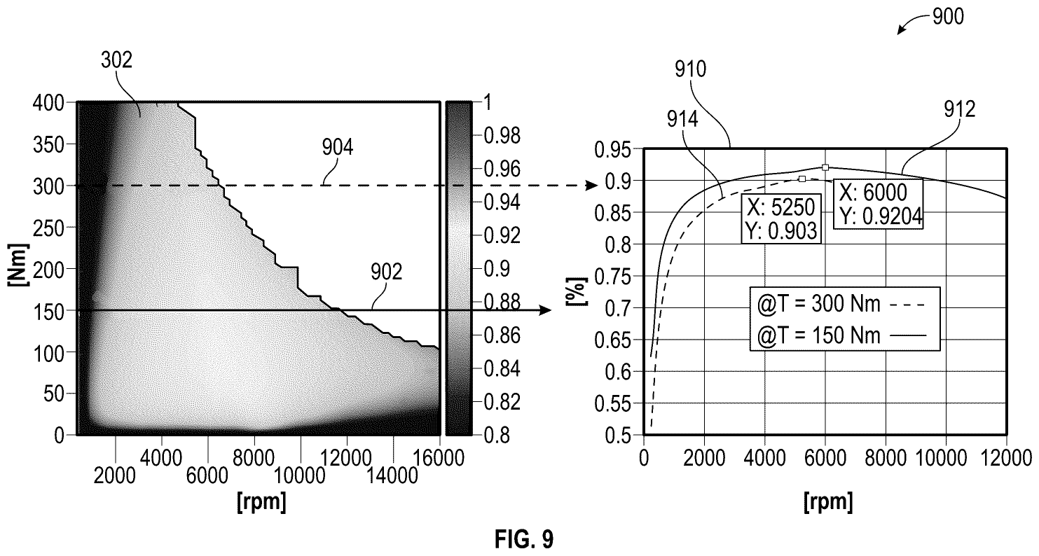

FIG. 9 illustrates an optimization operation 900 for a limp home mode in which extra devices are turned off. A first constant torque line 902 and a second constant torque line 904 are shown in the drive efficiency model 302. Graph 910 shows a first speed trace 912 corresponding to the first constant torque line 902 and a second speed trace 914 corresponding to the second constant torque line 904. The optimization technique can be used to find a peak or optimal speed for a given load in unconstrained speed situations with a disregard to speed limits.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of operating an electric vehicle, comprising:
obtaining a value of a current torque at which an electric drive system of the vehicle is operating;
determining, via a processor, an optimal speed for the vehicle for the current torque based on an efficiency model of the electric drive system, wherein the optimal speed corresponds to an optimal drive efficiency for the electric drive system; and
operating the vehicle at the optimal speed.

2. The method of claim 1, further comprising selecting a speed trace corresponding to the current torque from the efficiency model and locating the optimal speed using the speed trace.

3. The method of claim 2, wherein the optimal speed corresponds to one of: (i) a global optimal efficiency of the speed trace; and (ii) a local optimal efficiency within a bounded speed region of the speed trace defined by a constraint.

4. The method of claim 1, further comprising selecting a plurality of speed traces from within a neighborhood of the current torque and determining the optimal drive efficiency using the plurality of speed traces.

5. The method of claim 1, wherein the efficiency model is one of: (i) a drive efficiency model for the electric drive system; (ii) an inverter efficiency model for an inverter; and (iii) a motor efficiency model for an electric motor.

6. The method of claim 1, wherein operating the vehicle at the optimal speed comprises one of: (i) applying the optimal speed autonomously; and (ii) displaying a speed range for the optimal speed to a driver of the vehicle.

7. The method of claim 1, further comprising determining the optimal speed based on a relation between vehicle speed and a drag force on the vehicle.

8. An electric drive system for an electric vehicle, comprising:
a processor configured to:
obtain a value of a current torque at which the electric drive system of the vehicle is operating;
determine an optimal speed for the vehicle for the current torque based on an efficiency model of the electric drive system, wherein the optimal speed corresponds to an optimal drive efficiency for the electric drive system; and
operate the vehicle at the optimal speed.

9. The electric drive system of claim 8, wherein the processor is further configured to select a speed trace corresponding to the current torque from the efficiency model and locate the optimal speed using the speed trace.

10. The electric drive system of claim 9, wherein the optimal speed corresponds to one of: (i) a global optimal efficiency of the speed trace; and (ii) a local optimal efficiency within a bounded speed region of the speed trace defined by a constraint.

11. The electric drive system of claim 8, wherein the processor is further configured to select a plurality of speed traces from within a neighborhood of the current torque and determine the optimal drive efficiency using the plurality of speed traces.

12. The electric drive system of claim 8, wherein the efficiency model is one of: (i) a drive efficiency model for the electric drive system; (ii) an inverter efficiency model for an inverter; and (iii) a motor efficiency model for an electric motor.

13. The electric drive system of claim 8, wherein the processor is further configured to operate the vehicle at the optimal speed by performing one of: (i) applying the optimal speed autonomously; and (ii) displaying a speed range for the optimal speed to a driver of the vehicle.

14. The electric drive system of claim 8, wherein the processor is further configured to determine the optimal speed based on a relation between vehicle speed and a drag force on the vehicle.

15. An electric vehicle, comprising:
an electric drive system for providing a current torque to a wheel of the electric vehicle; and
a processor configured to:
obtain a value of the torque at which the electric drive system of the vehicle is operating;
determine an optimal speed for the vehicle for the current torque based on an efficiency model of the electric drive system, wherein the optimal speed corresponds to an optimal drive efficiency for the electric drive system; and
operate the vehicle at the optimal speed.

16. The electric vehicle of claim 15, wherein the processor is further configured to select a speed trace corresponding to the current torque from the efficiency model and locate the optimal speed using the speed trace.

17. The electric vehicle of claim 16, wherein the optimal speed corresponds to one of: (i) a global optimal efficiency of the speed trace; and (ii) a local optimal efficiency within a bounded speed region of the speed trace defined by a constraint.

18. The electric vehicle of claim 15, wherein the processor is further configured to select a plurality of speed traces from within a neighborhood of the current torque and determine the optimal drive efficiency using the plurality of speed traces.

19. The electric vehicle of claim 15, wherein the processor is further configured to operate the vehicle at the optimal speed by performing one of: (i) applying the optimal speed autonomously; and (ii) displaying a speed range for the optimal speed to a driver of the vehicle.

20. The electric vehicle of claim 15, wherein the processor is further configured to determine the optimal speed based on a relation between vehicle speed and a drag force on the vehicle.
